(19) United States
(12) Patent Application Publication
(10) Pub. No.: US 2016/0003278 A1
(43) Pub. Date: Jan. 7, 2016

(54) RELEASABLE CONNECTION APPARATUS AND METHOD

(71) Applicant: THORCO INDUSTRIES LLC, Lamar, MO (US)

(72) Inventors: Michael P. O'Sullivan, Lamar, MO (US); Ruston Van Hawes, Lamar, MO (US)

(21) Appl. No.: 14/324,675

(22) Filed: Jul. 7, 2014

(51) Int. Cl. F16B 13/06; F16B 12/32; F16B 12/10

(52) U.S. Cl. CPC F16B 13/063; F16B 12/10; F16B 12/32; F16B 2012/103

(57) ABSTRACT

Posts and beams are joined together using a connector having a radially expanding member positioned within a chamber of the beam and a bolt which passes through a hole in the post and is turned to expand the radially expanding member against the wall of the beam defining the chamber. The post and beam are decoupled from each other by turning the bolt in the opposite direction.

### CROSS-REFERENCED TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

I. Field of the Invention

The present invention relates to the connection of two members together. More specifically, the present invention relates to releasable connection techniques which may be employed to rigidly couple the two members together for some length of time and then release the connection to enable disassembly.

II. Related Art

Throughout history, various devices, tools and components have been employed to couple two members together. Early examples include nails, screws, rivets, combinations of nuts and bolts. More recently, adhesives, welds and solder have been employed to couple two members together.

Traditional joints include bridle joints, butt joints, miter joints, dovetail joints, dado joints, tongue-and-groove joints, mortise and tenon joints, and spliced joints. Such joints are capable of providing a firm connection between two members. However, the use of such joints often requires the members to be joined together to be fabricated in a particular way. Such fabrication adds time and expense to the creation of the joint. Further, the suitability of such joints often depends on the materials from which the materials to be joined are made.

joining two metal parts together often requires forming tabs, pockets, flanges or the like into the metal parts adding to the fabrication cost. Thus, there is a real need for joints for coupling metal parts together which do not require the parts to be fabricated with any special tabs, pockets or flanges. Of course, such tabs pockets and flanges may sometimes be eliminated when adhesives, solder, welds or some other bonding agent is employed. The use of such bonding agents, however, makes it difficult to later break the connection to permit disassembly without damaging the connected members. As such, there is also a real need for secure and stable joints which are easy to form and permit simple, easy and non-destructive disassembly of components.

The foregoing needs are particularly acute in the shelving and storage system industry. Prior art joints were employed to create shelving and storage systems or store fixtures and often resulted in an arrangement which (a) was difficult to assemble and disassemble, (b) was difficult and costly to manufacture and ship to an installation location, or (c) lacked the desired or necessary strength and stability.

All of the foregoing problems exist in the shelving and storage industry and in the store fixture industry. In these industries there is a real need for apparatuses and methods that solve the foregoing problems.

### SUMMARY OF THE INVENTION

The present invention solves all of the problems outlined above by providing components having common design elements and a novel connector assembly for releasably securing two of the components together.

For example, the components may include the vertical posts and horizontal beams of a shelving system or store fixture. The vertical posts and horizontal beams are formed in the same manner, such as by extrusion, so they have the same cross-section and other common design elements. The length of the posts may, of course, be different than the length of the beams. Likewise, different hole patterns may be punched or otherwise formed through the posts and/or beams.

The cross-section of the posts and beams may be c-shaped. More specifically, the posts and beams may each comprise an outer wall, a pair of side walls extending in the same direction (e.g., inwardly) from the opposite edges of the outer wall and lips extending toward each other from the front edges of the side walls. The aforementioned walls form a hollow chamber which is open to the opposite ends of the post or beam. A gap exists between the two lips which is wider than the length of the side walls. This permits the end of one component (e.g., a beam) to be passed between the lips and into the chamber of another component (e.g., a post). Since the gap in the post through which the end of the beam is passed is barely wide enough to receive the end of the beam, the beam cannot twist relative to the post adding considerably to the strength and rigidity of the assembly. The aforementioned holes of the post's hole pattern extend through the outer wall and are open to the front and back surfaces of the outer wall.

In one embodiment, the connector assembly includes a plate secured to a radially expanding block. The plate has a threaded bore. The block has a proximal end, a distal end, and a radially expanding section located between the proximal end and the distal end of the block. A channel extends between and is open to the proximal and distal ends of the blocks The channel is axially aligned with the threaded bore of the plate. The connector assembly also includes a bolt.

To form a connection between two components to be joined together, the plate and radially expanding section of the block are advanced through the open end of a first of the two components (e.g., a beam) until the block generally resides within the chamber of the first component. Then, the end of the first component is passed through the gap between the lips of the other component (e.g., a post) until the end of the first component engages the inside surface of the outer wall of the second component. The channel of the block is then aligned with a one of the mounting holes through the outer wall of the second component. The threaded shaft of a bolt is then inserted through the mounting hole of the second component and the channel of the block and mates with the threaded opening of the plate. Turning of the bolt in a first direction pulls the plate longitudinally toward the outer wall of the second component and causes the radially expanding section of the block to expand and press against the inside surfaces of the first component thus firmly joining the first and second components together. Disassembly is achieved by turning the bolt in the opposite direction to cause the plate to move away from the back wall of the second component permitting the radially expanding section of the block to contract such that the distal plate and the block can be pulled out of the end of the first component. Alternatively, the two joined components may be separated by removing the bolt while leaving the block and plate in place within the chamber of the first component.

In another embodiment, the connector assembly again includes a plate secured to a radially expanding block. The plate has two threaded bores. The block has a proximal end, a distal end, and a radially expanding section located between the proximal end and the distal end of the block. Two channels extend between and are open to the proximal and distal ends of the block. Each of the channels is axially aligned with a threaded bore of the plate. The connector assembly also includes two bolts.

To form a connection between two components to be joined together, the plate and radially expanding section of the block are again advanced through the open end of a first of the two components (e.g., a beam) until the block generally resides within the chamber of the first component. Then, the end of the first component is passed through the gap between the lips of the other component (e.g., a post) until the end of the first component engages the inside surface of the outer wall of the second component. The two channel of the block are next aligned with a pair of the mounting holes extending through the outer wall of the second component. The threaded shafts of the bolt are then inserted through the pair of mounting holes of the second component and the channels of the block to mate with the threaded openings of the plate. Turning of the bolts in a first direction pulls the plate longitudinally toward the outer wall of the second component and causes the radially expanding section of the block to expand and press against the inside surfaces of the first component thus firmly joining the first and second components together. Disassembly is achieved by turning the bolts in the opposite direction to cause the plate to move away from the back wall of the second component thereby permitting the radially expanding section to contract such that the distal plate and the block can be pulled out of the end of the first component. Alternatively, the two joined components may be separated by removing the two bolts while leaving the block and plate in place in the chamber of the first component.

The result of either of the two embodiments described above is a low cost, sturdy connection which is easily made and easily released using only a single tool such as a wrench or screw driver to tighten or loosen the bolt(s), Other arrangements may be employed to eliminate the need for tools when connecting the first and second components together.

These and other advantages will be more readily appreciated and understood from a review of the following detailed description in view of the accompanying drawings.

### BRIEF DESCRIPTION OF THE DRAWINGS

The foregoing features, objects and advantages of the invention will become apparent to those skilled in the art from the following detailed description and with reference to the following drawings in which like numerals in the several views refer to corresponding parts.

FIG. 1 is a perspective view of a rack assembled using the connectors of the present invention.

FIG. 2 is an exploded view showing one of the connections made in accordance with the present invention.

FIG. 3 is an end view of a component used to form the rack.

FIG. 4 is a schematic diagram showing a connector made in accordance with the present invention.

FIG. 5 is a schematic diagram showing one of the connector of FIG. 4 in its radially expanded state.

FIG. 6 is a view of the distal end of the connector of FIGS. 3 and 4 positioned inside the chamber of the component of FIG. 3.

FIG. 7 is a plan view showing an alternative embodiment of the radially expanding block of a connector.

FIG. 8 is a plan view of the block of FIG. 7 in its radially expanded state.

FIG. 9 is a plan view showing a plate embedded inside the block of FIGS. 7 and 8.

FIG. 10 is an exploded view showing two connections made in accordance with still another alternative embodiment of present invention.

FIG. 11 is an exploded view of one of the connections of the embodiment shown in FIG. 10.

### DETAILED DESCRIPTION

This description of the preferred embodiment is intended to be read in connection with the accompanying drawings, which are to be considered part of the entire written description of this invention. in the description, relative terms such as “lower”, “upper”, “horizontal”, “vertical”, “above”, “below”, “up”, “down”, “top” and “bottom”, “under”, as well as derivatives thereof (e.g., “horizontally”, “downwardly”, “upwardly”, “underside”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “joined”, and “joining” are used interchangeably and refer to one structure or surface being secured to another structure or surface or integrally fabricated in one piece unless expressly described otherwise.

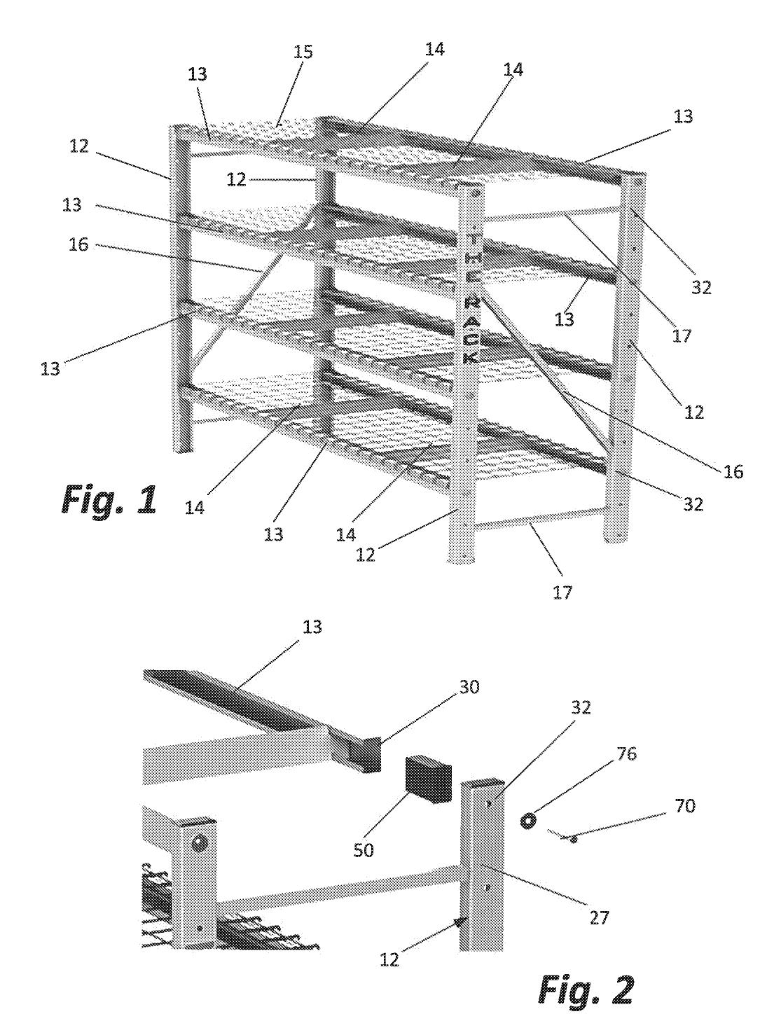

FIGS. 1 and 2 show a rack 10 assembled using the connectors of the present invention. The rack 10 includes a front assembly and a back assembly each comprising two vertical posts 12 and four horizontal beams 13. The front and back assemblies are joined together by horizontal rails 14. Each horizontal rail 14 extends between a pair of horizontal beams 13, specifically beams 13 of the front and back assemblies mounted at substantially the same height. FIG. 1 shows a pair of horizontal rails 14 extending between each pair of beams 13. Alternatively, a single horizontal rail 14 may extend between each pair of beams 13 at the center of the beams 13. Mesh shelves 15 are supported by the horizontal beams 13 and rails 14. Transverse supports 16 and horizontal support 17 may also be provided for enhanced stability.

The vertical posts 12, the horizontal beams 13 and even the horizontal rails 14 may all have the same structure, the only difference being their respective lengths. For example, all may be formed as an identical extrusion and cut to a desired length. Alternatively, the horizontal rails 14 may have a different structure than the posts 12 and beams 13. For example, the rails 14 may have an inverted V-shape which prevents twisting of the rail when extreme weight is placed on the shelf.

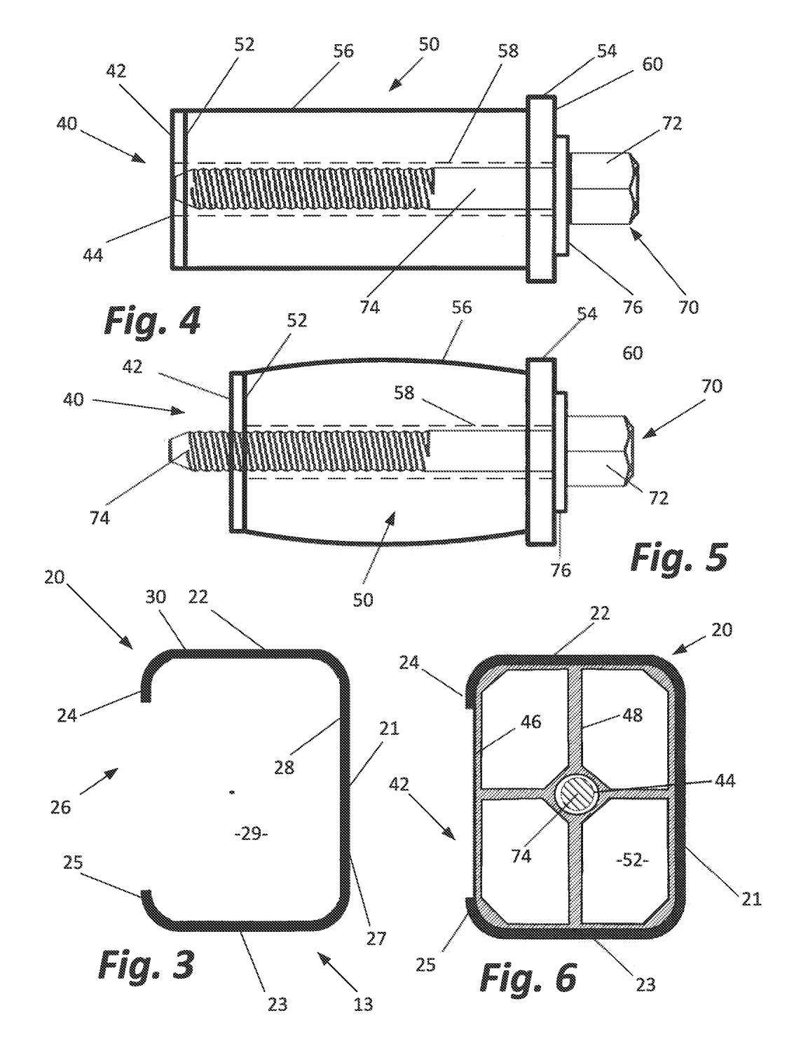

FIG. 3 shows the cross-section of the post 12 and beams 13. The post 12 and beams 13 each have a wall 20. The wall 20 comprises an outer wall section 21 and a first side wall section 22 and second side wall section 23 extending inwardly from the opposite edges of the outer wall section 21 at substantially a right angle. The outer wall section 21 defines the width of the component and the first and second side wall sections 22/23 define the depth of the component. A lip 24 extends from the inner end of side wall section 22 and a lip 25 extends from the inner end of side wall section 23. The free ends of lips 24 and 25 are separated by a gap or channel 26 which is slightly wider than the depth of the component. The wall 20 has an outside surface 27 and an inside surface 28. The post 12 and beam 13 components are hollow. As such, the inside surface 28 surrounds a chamber 29. The ends 30 of the post 12 and beams 13 components are open to the chamber 29. Also, a plurality of mounting holes 32 extend through the outer wall section 21 of the post 12. The holes 32 are open to the inside surfaces 29 and outside surfaces 27 of the outer wall sections 21 of the post 12. Similar mounting holes may be, but are not necessarily, punched through the beams 13. Providing such holes in the beams 13 will depend on what items will be attached to the beam 13 and how such items will be attached to the beam 13.

As illustrated in FIGS. 1 and 2, the ends 30 of the horizontal beams 13 are inserted through the channels 26 and into the chambers 29 of two vertical posts 12. Likewise, the ends of the horizontal rails 14 are inserted through the channels 26 and into the chambers 29 of two horizontal beams 13. A connection coupling an end 30 of one component (e.g., a beam 13) in place inside a chamber 29 of a second component (e.g., post 12) is made using a connector 40.

One form of connector 40 is illustrated in FIGS. 4-6. This connector 40 has a distal plate 42 comprising a central threaded bore 44, a frame 46 and engagement surfaces 48. The connector 40 also has a radially expending block 50. Block 50 may be integrally formed of a resilient material. Block 50 has a distal surface 52 (visible through openings in the distal plate 42 in FIG. 6) adapted to be placed in face-to-face registration with and coupled to the distal plate 42. The block 50 also has a proximal flange 54. Extending between the proximal flange 54 and the distal surface 52 is a radially expanding section 56. A central channel 58 runs the entire length of block 50 and is open to both the proximal end 60 and distal end 52 of block 50. The connector 40 also includes a bolt 70. Bolt 70 has a head 72 and a threaded shaft 74. One or more washers 76 may also be employed.

As best seen in FIG. 2, the distal plate 42 and distal surface or end 52 of block 50 are inserted into the end 30 of a first component (such as a horizontal beam 13) until the radially expanding section 56 resides within the chamber 29 and the flange 54 comes to rest against the end of the component. Next, the end of the first component (e.g., horizontal beam 13) is passed through the channel 26 and into the chamber 29 of a second component (e.g., the vertical post 12). The first component (beam 13) is moved vertically until a selected hole 32 of the second component (post 12) is in alignment with the channel 58 of the block 50 and the central threaded bore 44 of the distal plate 42. Next, the shaft of bolt 70 is inserted through a washer 76, the selected hole 32 of the second component (post 12), the central channel 58 of the block 50 and finally into the threaded bore 44 of the distal plate 42.

Turning (or tightening) of the bolt 70 with respect to the distal plate 42 initially serves to draw the flange 54 of the block 50 into contact with the inside surface 28 of the outer wall section 21 of the vertical post 12. Continued tightening of the bolt 70 longitudinally compresses and radially expands the radially expanding section 56 of the block 50 such that block 50 transitions from the shape shown in FIG. 3 to the shape shown in FIG. 4. More specifically, as the bolt 70 is tightened, a pinching force is applied to block 50 by the distal plate 42 and the inside surface 28 of wall section 21 of the first component (e.g., beam 13). It is this pinching force that causes the radial expansion of the radially expanding section 56 of block 50.

Alternatively, some sort of lock-down bolt actuated by a lever may be employed to eliminate the need for a tool to turn the bolt. When such a lock-down bolt is employed, the threads join the bolt to the plate 42 and actuation of the lever pulls on the bolt's shaft to draw plate 42 toward the proximal end 60 of the block 50 to radially expand the block 50.

Forming the connection described above is hastened by the arrangement illustrated in FIGS. 4-6. As shown in FIG. 6, the distal plate 42 and the radially expanding section 56 of block 50 essentially fill the entire cross-section of the chamber of the horizontal beam 13 before the block 50 is radially expanded. As radial expansion of the block 50 begins, the outer wall of the radially expanding section 56 immediately and firmly engages the inside surface of wall 20 of beam 13 forming a tight stable and secure connection between the horizontal beam 13 and vertical post 12.

When one wishes to disconnect the post 12 and beam 13 from each other, one simply loosens the bolt 70. Removing the bolt 70 entirely detaches the post 12 from the beam 13 while leaving the distal plate 42 and block 50 in place within the beam 13. Alternatively, one can simply loosen the bolt 70, thereby permitting contraction of the radially expanding section 56 of block 50, without decoupling the bolt 20 from the distal plate 42. Once the radially expanding section 56 of block 50 has contracted, one can easily slide the distal plate 42 and block 50 out of the beam 13 such that these parts, but not the beam, remain connection to the post 12.

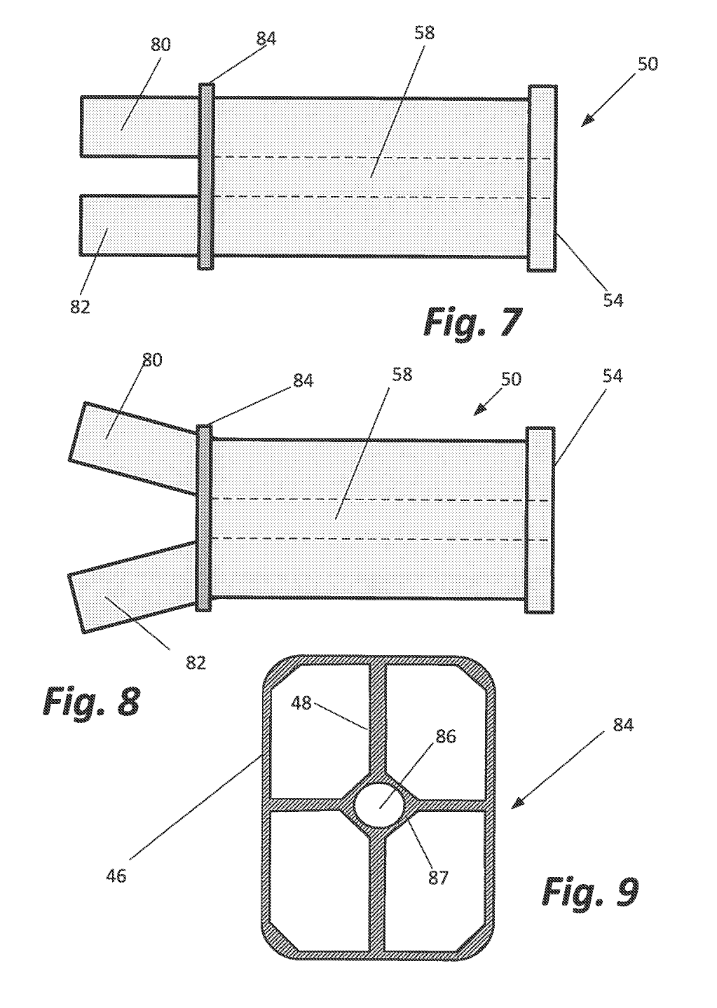

FIGS. 7-8 show an alternative embodiment of the block 50. In this embodiment, the block 50 includes a proximal flange 54 and a central channel 58. The block also includes four radially expanding legs (legs 80 and 82) extending distally from a distal surface of the block. Two such legs 80 and 82 are shown. A plate 84, illustrated in FIG. 9, is adjacent the distal surface the block 50 such that the legs extend through openings in the plate 84. Plate 84 includes a central threaded bore 86 through a bearing surface 87. The bore 86 is aligned with the channel 58 of the block 50. In this embodiment, tightening (or loosening) of the bolt 70 causes plate 84 to move longitudinally and the legs 80 and 82 to move radially between the positions shown in FIGS. 7 and 8.

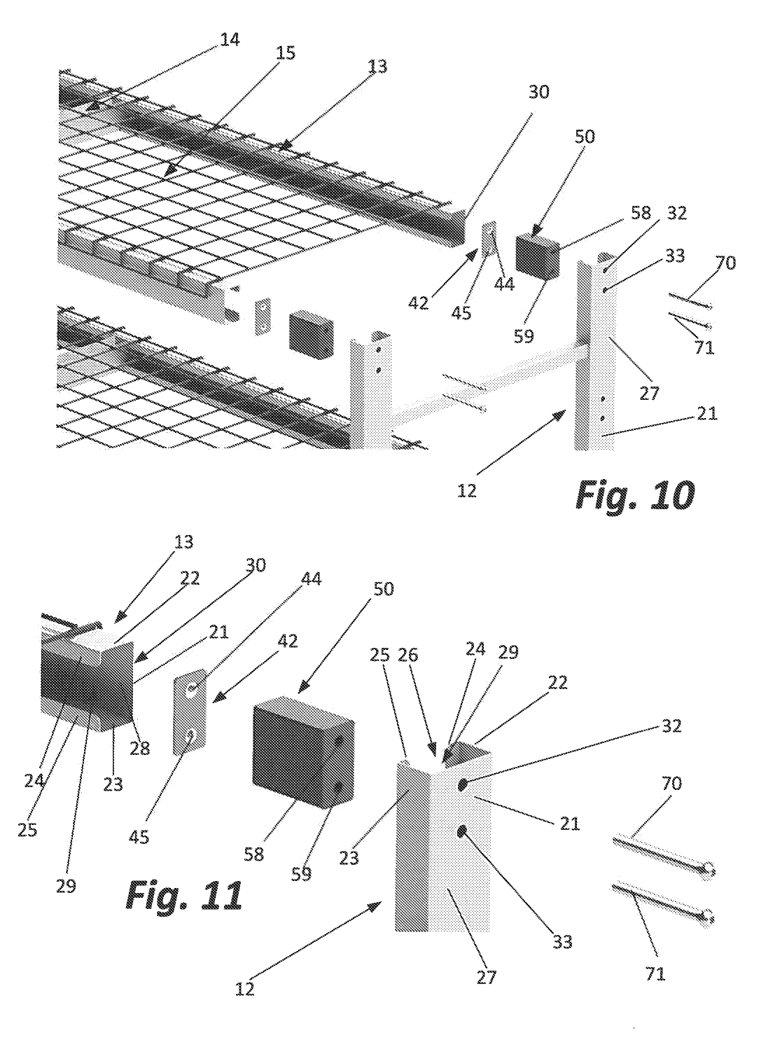

FIGS. 10 and 11 illustrate still another embodiment. In this embodiment, the block 50 has been modified to eliminate the flange and provide two channels 58 and 59 open to the proximal and distal ends of the block. The distal plate 42 has also been modified so it is essentially a solid plate with two threaded bores 44 and 45 extending through the plate. Likewise, two bolts 70 and 71 are provided and two mounting holes 32 and 33 are punched through wall 27 of post 12.

As best is illustrated in FIGS. 11, a post 12 and beam 13 may be coupled together in several easy steps. First, the distal plate 42 and then the block 50 are inserted through the end 30 so they are positioned within the chamber 29 of the beam 13. When so positioned, threaded hole 44 of the distal plate 42 is axially aligned with the channel 58 of block 50. Likewise, threaded hole 45 of plate 42 is axially aligned with the channel 59 of block 50. Second, the end 30 of bean 13 is passed through the gap 26 between the lips 24 and 25 and into the chamber 29 of post 12. Third, the channel 58 and threaded bore 44 are aligned with mounting hole 32 and channel 59 and threaded bore 45 are aligned with mounting hole 33. Fourth, the threaded end of bolt 70 is advanced through mounting hole 32 and channel 58 and coupled to the threaded bore 44. Likewise, bolt 71 is advanced through mounting hole 33 and channel 59 and coupled to the threaded bore 45. Finally, the bolts 70 and 71 are tightened in tandem so that the distal plate 42 is pulled toward the wall 21 of the post 12 thereby longitudinally compressing and radially expanding the block 50 against the inside surface 28 of walls 21, 22, and 23, and lips 24 and 25 of the beam 13. Drawing the post 12 and beam 13 together and radially expanding block 50 against the walls defining the chamber 29 of beam 13 provides a strong and stable connection.

The post can be decoupled from the beam by simply loosening the bolts 70 and 71 to reduce the radial dimensions of the block 50 and then sliding the assembly of of the bolts 70 and 71, the block 50 and plate 45 out of the end 30 of the beam 13. Alternatively, the bolts 70 and 71 can be entirely removed while leaving the block 50 and plate 42 within the chamber 29 of beam 13.

Various advantages are achieved using the connectors described above. First, use of the connectors eliminates the need for brackets or welds on the vertical posts 12, horizontal beams 13 or horizontal rails 14. Second, fabrication of the posts 12 and beams 13 is simplified because they all may be constructed to have the same profile and cross-section such that the only difference between the posts 12 and beams 13 is their respective lengths and the existence and position of holes punched through the post or beam. Third, no welding is required to couple the beams 13 to either the posts 12 or the rails 14. Fourth, the assembly results in each shelf being capable of carrying a load in excess of 2000 pounds. Fifth, packaging of the rack for shipment prior to assembly is simplified. Sixth, assembly is carried out quickly and with ease. Finally, the overall result is a heavy duty rack or store fixture which is aesthetically acceptable, having no exposed sharp edges which may be provided at a lower cost.

The foregoing description is intended to explain the various features and advantages, but is not intended to be limiting. The connectors, for example, can be applied in a number of ways other than to construct a rack of shelves.

Also, various modifications may be made without deviating from the invention. For example, the distal plate may be in the form of a nut or, to increase the surface area, a nut and a washer located within the radially expanding member 50 or adjacent the distal end 52 of the radially extending member 50 cooperating with the bolt 70 to cause the radially expanding member 50 to expand radially. Also, the bolt can be embedded into the block 50 such that the bolt head 72 acts as the distal plate and the threaded shaft 74 extends past the proximal flange 54 of the block 50. When this alternative arrangement is employed, the block 50 is inserted through the end of horizontal beam 13 until the proximal flange 54 engages the end of beam 13. The end of the beam 13 is then passed through the channel 26 into the chamber 29 of the post 12 and the threaded shaft 74 of the bolt 70 is passed through a selected one of the openings 32 in the outer wall section 21 of the post 12. A nut is then tightened onto the bolt 70 such that the bolt head 72 is drawn toward the outer wall section 21 of the post 12 radially expanding the block 50 to form a secure connection between the post 12 and beam 13. The nut can be in the form of a wing nut so that it is easily gripped and turned without any tool being required. The scope of the invention is defined by the following claims which are also intended to cover a reasonable range of equivalents.

What is claimed is:

1. A releasable connection comprising:
a, a first component having an end and a wall defining a chamber which is open to the end.
b. a second component having a wall and a hole extending through the wall; and
c. a connector assembly comprising a radially expanding member and a bolt, said radially expanding member including a plate having a threaded opening, and a block having a radially expanding section and a channel axially aligned with the threaded opening of the plate, said bolt having a threaded shaft adapted to be inserted through the hole of the second component, and the channel of the block and joined with the threaded opening of the plate, wherein turning the bolt in a first direction draws the plate toward. the wall of the second component and radially expands the radially expanding section. against the wall defining the chamber of the first component thereby joining the first and second components together and turning the bolt in a second direction allows the joined first and second components to be released from each other.

2. The releasable connection of claim 1 wherein the second component has a second hole extending through the wall, and the connector assembly further includes a second bolt, a second threaded opening in the plate and a second channel through the block axially aligned with the second threaded opening of the plate, said second bolt having a threaded shaft adapted to be inserted through the second hole of the second component, and the second channel of the block and joined with the second. threaded opening of the plate.

3. The releasable connection of claim 1 wherein the wall of the first component and the wall of the second component each have an outside wall section defining the width of the component, first and second side wall sections extending in the same direction from opposite edges of the outside wall section defining the depth of the component, and a pair of lips extending toward each other from the first and second wall sections and separated from each other by a gap wider than the depth of the other of the first and second components.

4. The releasable connection of claim 1 wherein the block has a distal end and a proximal flange and the radial expanding section is located between the proximal flange and distal end.

5. The releasable connection of claim 4 wherein the plate is in face-to-face registration with the distal end of the block.

6. The releasable connection of claim 4 wherein the plate is embedded in the block.

7. The releasable connection of claim 1 wherein the radially expanding section of the block comprises a pair of legs.

8. The releasable connection of claim 1 wherein the first component is a horizontal beam and the second component is a vertical post.

9. The releasable connection of claim 1 wherein the vertical post has a plurality of holes and the bolt is passed through a selected one of the plurality of holes.

10. A releasable connection for joining a horizontal beam to a vertical post comprising.
a. a first horizontal beam having an end and a wall defining a chamber which is open to the end;
b. a first vertical post having a wall and a hole extending through the wall; and
c. a first connector assembly comprising a radially expanding member and a bolt, the radially expanding member including a block having a radially expanding section, a plate having a threaded opening and a channel through the block axially aligned with the threaded opening of the plate, said plate and said radially expanding section located within the chamber of the horizontal beam, the bolt having a shaft adapted to pass through the hole of the vertical post and the channel of the block and joined to the threaded opening of the plate, wherein. turning the bolt in a first direction draws the end of the horizontal beam toward the wall of the vertical post and radially expands the radially expanding section against the wall of the horizontal beam thereby frictionally joining the horizontal beam to the vertical post, and wherein turning the bolt in a second direction allows the horizontal beam and vertical post to be separated from each other.

11. The releasable connection. of claim 10 wherein the wall of the horizontal beam and the wall of the vertical post each comprise an outside wall section defining the width, first and second side wall sections extending in the same direction from opposing side edges of the outside wall section defining the depth, and a pair of lips extending toward each other from the first and second wall sections and separated from each other by a gap wider than the depth.

12. The releasable connector of claim 10 wherein the block has a distal end and proximal flange adapted to engage the end of the horizontal beam, wherein the radially expanding section is located between the proximal flange and the distal end, and wherein the radially expanding section is adapted to be expanded into firm contact with the wall defining the chamber of the horizontal beam.

13. The releasable connection of claim 10 wherein the horizontal beam and the vertical post are of the same cross-sectional design.

14. The releasable connection of claim 10 wherein. the horizontal beam has a second end connected to a second vertical post using a second connector assembly identical to the first connector assembly.

15. The releasable connection of claim 14 further comprising a second horizontal beam having a first end connected to the first vertical post using a third connector assembly identical to the first connector assembly and a second end connected to the second vertical post using a fourth connector assembly identical to the first connector assembly.

16. A releasable connection comprising:
a. a first component having an open end and a first wall defining a chamber which is in communication with the open end;
b. a second component having a second wall and a plurality of holes extending through the second wall; and
c. a connector assembly comprising:
(i) a block having a radially expanding section having a first state in which the radially expanding section is adapted to be inserted into and removed from the chamber through the open end and a second radially expanded state in which the radially expanded section firmly engages the first wall of the first component thereby retaining the radially expanding section within the chamber; and
(ii) means adapted to cooperate with the plurality of holes extending through the second wall to couple the second component to the block and to transition the radially expanding section of the block between the first state and the second radially expanding state to firmly and releasably couple the first component and second component together.

17. The releasable connection of claim 16 wherein said means comprises a plurality of bolts each having a threaded shaft adapted to extend through a hole in the second wall of the second component, a bore through the block and the open end of the first component.

18. The releasable connection of claim 17 wherein said means further comprises a plate coupled to the block, said plate having a plurality of threaded bores each adapted to mate with the threaded shaft of one of said plurality of bolts.

19. The releasable connection of claim 18 wherein said block has a distal surface and said plate engages the distal surface of the block.

20. The releasable connection of claim 16 wherein said means comprises two bolt and two nuts.
